(19) United States
(12) Patent Application Publication
(10) Pub. No.: US 2007/0091642 A1
(43) Pub. Date: Apr. 26, 2007

(54) Light guide plate and backlight unit having the same

(75) Inventors: Seoung Ho Lee, Gyeonggi-do (KR); Sang Gon Lee, Heungdeok-gu (KR)

Correspondence Address: MCKENNA LONG & ALDRIDGE LLP, 1900 K STREET, NW, WASHINGTON, DC, 20006, US

(73) Assignee: LG ELECTRONICS, INC., Seoul (KR)

(21) Appl. No.: 11/580,231

(22) Filed: Oct. 13, 2006

Related U.S. Application Data
(63) Continuation-in-part of application No. 11/313,796, filed on Dec. 22, 2005.

(30) Foreign Application Priority Data
Oct. 14, 2005 (KR) 10-2005-0096842
Oct. 14, 2005 (KR) 10-2005-0096844
May 15, 2006 (KR) 10-2006-0043575

(51) Int. Cl. F21V 7/04

(52) U.S. Cl. 362/621

(57) ABSTRACT

The present invention provides a light guide plate capable of improving brightness uniformity and a backlight unit having the same. The present invention also provides a liquid crystal display having such light guide plate and backlight unit. The light guide plate according to the present invention has a light incidence and a light emitting surface, wherein the light incidence surface is not perpendicular to the light emitting surface. The present invention utilizes the light guide plate capable of improving brightness uniformity across the light emitting surface so that the backlight unit and liquid crystal display may have considerably improved brightness uniformity.

### CROSS-REFERENCE TO RELATED APPLICATIONS

The present application is a Continuation-in-Part application of the application Ser. No. 11/313,796 filed on Dec. 22, 2005, entitled “BACKLIGHT UNIT,” which claims the benefit of priority under 35 U.S.C. 119 based on the following prior foreign applications: the Korean patent application numbers 10-2005-0096842 filed on Oct. 14, 2005 and 10-2005-0096844 filed on Oct. 14, 2005. The present application also claims the benefit of priority under 35 U.S.C. 119 based on the Korean patent application number 10-2006-0043575 filed on May 15, 2006. All of these applications are incorporated herein by reference.

### BACKGROUND OF THE INVENTION

1. Field of the Invention

The present invention is directed to a light guide plate capable of improving brightness uniformity and a backlight unit having the same. The present invention is also directed to a liquid crystal display having such light guide plate and backlight unit.

2. Description of the Related Art

Liquid crystal display, also known as LCD, is an electronic device that transforms electrical signals into visual signals by using the change in the transmittance of liquid crystals according to applied voltages.

As well known in the art, the liquid crystal display is a non-emitting display device. Therefore, the liquid crystal display needs to use an outside light source unit for illuminating uniformly the viewing plane of the liquid crystal panel from its outside in order to display information. The backlight unit is conventionally used to provide light to the viewing plane of the liquid crystal panel.

A cold cathode fluorescent lamp is generally employed for a light source in the backlight unit. The backlight unit may be classified into two types: direct type and edge-light type according to the position where the light source is disposed. In the direct type, the light source is disposed directly at the back of the liquid crystal panel, while in the edge-light type, the light source is disposed along a side surface of the light guide plate.

FIG. 1 is a cross-sectional view of an edge-light type backlight unit.

As shown in FIG. 1, the backlight unit 100 is comprised of light source units 110, a light guide plate 120, a reflective sheet 130 and optical films 140.

Each light source unit 110 comprises a light source 112 generating light and a light source reflector 114. The light generated at the light source 112 is mixed uniformly in the light guide plate 120 before being emitted through the upper surface of the light guide plate 120.

The light source reflector 114 and the reflector sheet 130 are formed of reflective materials so that they reflect the light toward the light guide plate 120 to improve the light efficiency of the backlight unit 100.

The optical films 140 generally are comprised of a diffuser sheet 142, a prism sheet 144 and a protector sheet 146. Hereinafter, the function of each component of the optical films 140 will be described.

While the light emitted through the upper surface of the light guide plate 120 passes through the diffuser sheet 142, the differ sheet 142 diffuses or collimates the light to make the brightness uniform across the upper surface of the diffuser sheet 142 and widen the viewing angle.

Because the brightness declines sharply while the light passes through the diffuser sheet 142, the prism sheet 144 is provided in the backlight unit 100 to compensate such declination of brightness. The prism sheet 144 refracts the light emitted from the diffuser sheet 142 in a low angle to collimate the light toward the front direction so that the brightness is improved within the effective viewing angle.

The protector sheet 146 is disposed over the prism sheet 144 to prevent the surface of the prism sheet 144 from being damaged, and to widen the viewing angle narrowed by the prism sheet 144.

As well known in the art, the conventional prism sheet 144 employed in the backlight unit 100 has an array of micro prisms formed on a surface of a base film. The array of micro prisms may be disposed toward the light guide plate 120 (what is known as “reverse prism sheet”), or toward the opposite position thereof (what is know as “forward prism sheet).

It is known that the reverse prism sheet is generally preferable than the forward prism sheet in terms of the light efficiency. A plane light source unit employing the reverse prism sheet is disclosed in U.S. Pat. No. 5,126,882, which is herein incorporated by reference.

The plane light source unit disclosed in the above publication has a structure where the light incidence surface through which the light generated from the light source unit is input into the light guide plate is perpendicular to the light emitting surface through which the light input into the light guide plate is emitted out of the light guide plate. However, the brightness uniformity deteriorates in such structure.

Therefore, there is still a need to develop the backlight unit and the liquid crystal display having the improved brightness uniformity.

### SUMMARY OF THE INVENTION

The present invention provides a backlight unit comprising a light source generating light; and a light guide plate configured to transform the light from the light source into surface light, the light guide plate including a light incidence surface wherein the light generated from the light source is input into the light guide plate through the light incidence surface; and a light emitting surface wherein the light input through the light incidence surface is emitted through the light emitting surface in the form of surface light, and wherein the angle which the light incidence surface and the light emitting surface of the light guide plate make with each other is less than 90°. Preferably, the angle made between the light incidence surface and the light emitting surface is larger than 85° and less than 90°.

The present invention also provides a backlight unit comprising a light source generating light; and a light guide plate configured to transform the light from the light source into surface light, the light guide plate including a light incidence surface wherein the light generated from the light source is input into the light guide plate through the light incidence surface; and a light emitting surface wherein the light input through the light incidence surface is emitted through the light emitting surface in the form of surface light, and wherein the angle which the light incidence surface and the light emitting surface of the light guide plate make with each other is larger than 90°. Preferably, the angle made between the light incidence surface and the light emitting surface is larger than 90° and less than 95°

The backlight unit of the present invention may further comprise a prism sheet including an array of micro-prisms disposed in parallel on a surface of the prism sheet, wherein the prism sheet is disposed in the backlight unit in such a manner that the array of micro-prisms faces the light emitting surface of the light guide plate.

Furthermore, the present invention provides a light guide plate configured to transform the light from a light source disposed adjacent to the light guide plate into surface light, the light guide plate including a light incidence surface wherein the light from the light source is input into the light guide plate through the light incidence surface; and a light emitting surface wherein the light input through the light incidence surface is emitted through the light emitting surface in the form of surface light, and wherein the light incidence surface is not perpendicular to the light emitting surface.

According to one embodiment of the present invention, the angle made between the light incidence surface and the light emitting surface is less than 90°. According to another embodiment of the present invention, the angle made between the light incidence surface and the light emitting surface is larger than 90°

### BRIEF DESCRIPTION OF THE DRAWINGS

These and other features, aspects and advantages of the present invention will become better understood with regard to the following description, appended claims, and accompanying drawings where:

FIG. 1 is a cross-sectional view of an edge-light type backlight unit;

FIG. 2A is a cross-sectional view of a liquid crystal display according to an embodiment of the present invention;

FIG. 2B is a cross-sectional view of an example of the liquid crystal panel shown in FIG. 2A;

FIG. 2C is an enlarged partial cross sectional view illustrating a part of the backlight unit shown in FIG. 2A;

FIG. 3 is a partial cross-sectional view of a backlight unit according to another embodiment of the present invention;

FIG. 4 is a partial cross-sectional view of a backlight unit according to further another embodiment of the present invention;

FIG. 5 is a partial cross-sectional view of a backlight unit according to yet further another embodiment of the present invention;

FIGS. 6A-6B illustrate the paths of the light in the light guide plate of the related art and the light guide plate of the present invention respectively; and

FIG. 7 is a diagram illustrating test data measuring the brightness property of the backlight unit of the present invention.

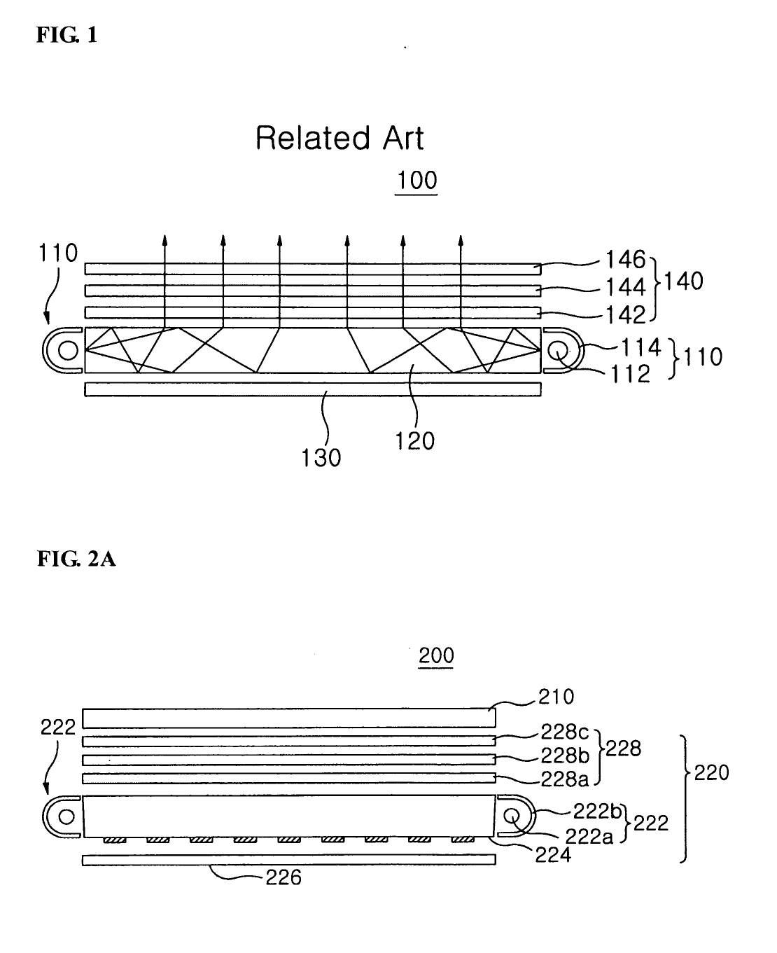

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

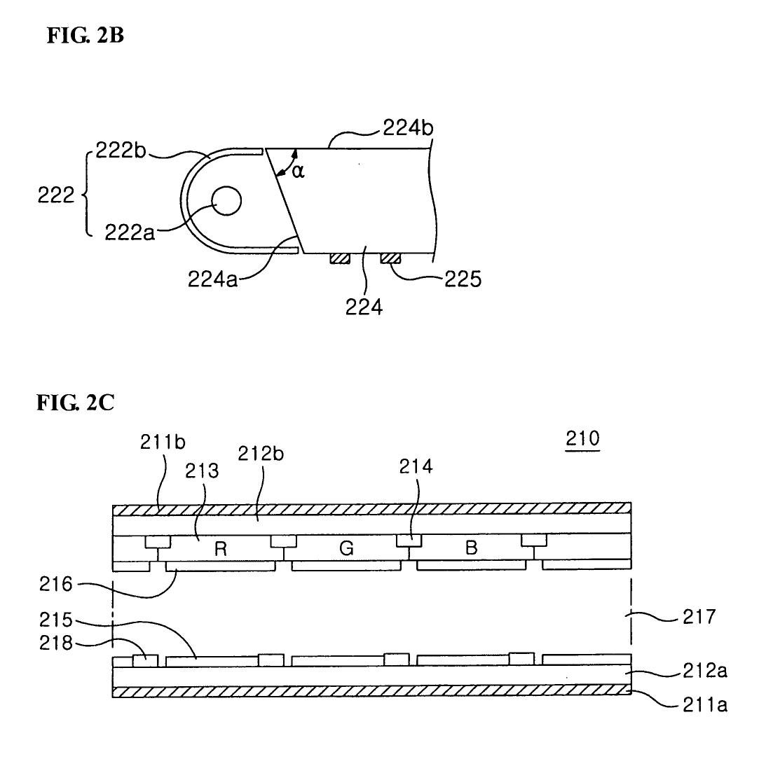

FIG. 2A is a cross-sectional view of a liquid crystal display according to an embodiment of the present invention; FIG. 2B is a cross-sectional view of an example of the liquid crystal panel shown in FIG. 2A; and FIG. 2C is an enlarged partial cross-sectional view illustrating a part of the backlight unit shown in FIG. 2A, which shows the light source unit 222 and a portion of the light guide plate 224 adjacent to the light source unit.

Referring to FIGS. 2A-2C, the liquid crystal display 200 comprises a liquid crystal panel 210 and a backlight unit 220. The liquid crystal panel 210 displays images according to driving signals and data signals provided by the outside device. The backlight unit 220 is disposed at the back of the liquid crystal panel 210 to provide light to the liquid crystal panel 210.

To understand and work the present invention, it is not important to describe the detailed structure of the liquid crystal panel 210. And, the idea of the present invention is widely applicable to any type of liquid crystal panel usually employed in the liquid crystal display. Therefore, the structure of the liquid crystal panel 210 described hereinafter is presented only for the purpose of an example to help understand the present invention.

The liquid crystal panel 210 comprises a lower substrate 212a, an upper substrate 212b, a color filter 213, a black matrix 214, pixel electrodes 215, a common electrode 216, a liquid crystal layer 217, TFT array 218 and a pair of polarizer films 2121, 211b each disposed on the outer surfaces of the lower and upper substrates 212a, 212b respectively.

The color filter 213 includes color filters which correspond to red color R, green color G and blue color B and generate images corresponding to red, green and blue colors when light is provided to them.

The TFT array 218 is a set of switching devices for switching the pixel electrodes 215.

The common electrode 216 and pixel electrodes 215 change the arrangement of liquid crystal molecules in the liquid crystal layer 217 according to applied voltages.

The liquid crystal layer 217 consists of a plurality of liquid crystal molecules. The liquid crystal molecules change their arrangement with the voltage difference generated between the pixel electrode 215 and common electrode 216, thereby the light provided from the backlight unit 220 is input into the color filter 213

The backlight unit 220 is disposed at the back of the liquid crystal panel 210 to provide light, for example white light.

The backlight unit 220 comprises light source units 222, a light guide plate 224 and optical sheets 228. The backlight unit 220 is of the edge-light type wherein the light source units 222 are disposed along the two side surfaces of the light guide plate 224.

Each light source unit 222 comprises a light source 222a and a light source reflector 222b disposed at the outside of the light source 222a. The light generated at the light source unit 222 is input into the light guide plate 224.

The light source 222a according to an embodiment of the present invention is a linear light source such as a cold cathode fluorescent lamp (CCFL) and external electrode fluorescent lamp (EEFL). The light source 222a according to another embodiment of the present invention is a point light source such as a light emitting diode (LED).

The light source reflector 222b is disposed outside the light source 222a. The light source reflector 222b may be made of metal or plastic. The inner surface of the light source reflector 222b may be coated with a light reflective material to reflect the light from the light source 222a to the side surface of the light guide plate 224.

The light generated from the light source 222a is input into the light guide plate 224 through its side surface, i.e. the light incidence surface 224a to improve the light efficiency.

The light guide plate 224 mixes the light input through the light incidence surface 224a before emitting the light through the light emitting surface while transporting the light in a direction substantially parallel to the viewing plane of the liquid crystal panel 210 located at the upper position by the principle of total reflection.

The light guide plate 224 according to the present invention has a structure where the light incidence surface 224a is not perpendicular to the light emitting surface 224b and inclined toward the inner side of the light guide plate 224.

In particular, as shown in FIG. 2C, the angle α made between the light incidence surface 224a and the light emitting surface 224b is less than 90°, and such structure improves the brightness uniformity of the light emitted across the light emitting surface 224b of the light guide plate 224. Therefore, the light guide plate 224 having the above described structure may also improve the brightness uniformity of the backlight unit 220 and the liquid crystal display 200.

The total reflection must be transformed to the scattered reflection in order for the light at the inside of the light guide plate 224 to be emitted toward the liquid crystal panel 210. For this purpose, light scattering patterns 225 may be printed on the lower surface of the light guide plate 224 by using dot-printing techniques.

Alternatively, a print-less type light guide plate which does not need printing process may be used. U.S. Pat. No. 6,123,431 discloses a print-less type light guide plate which has light scattering patterns obtained by forming grooves on a surface of the light guide plate, and U.S. Pat. No. 6,123,431 discloses another print-less type light guide plate having additionally the function of a diffuser plate. The light guide plate disclosed in the U.S. Pat. No. 6,123,431 is obtained by dispersing inorganic or organic particles having different refractivity from that of the basic resin in the light guide plate to provide the light guide plate with the scattering function, wherein the scattering may occur from the difference of the refractivity between the basic resin and the inorganic (or organic) particles. The above publications are herein incorporated by reference.

Alternatively, the so-called prism light guide plate which has an array of linear prisms on the opposite surface to the light emitting surface may be used for the light guide plate 224. U.S. Pat. No. 6,502,947 and U.S. Pat. No. 6,874,902 disclose the above described prism light guide plate. The publications are herein incorporated by reference.

The light guide plate 224 may consist of a transparent acrylic resin such as polymethyl methacrylate (PMMA).

The reflector sheet 226 is disposed under the light guide plate 224 to re-input the light emitted through the lower surface of the light guide plate 224 into the light guide plate 224.

The reflector sheet 226 may be manufactured by applying Ag on a sheet made of SUS, Brass, Al, PET, etc and coating it with Ti to prevent the thermal deformation caused by serious heat absorption.

Alternatively, the reflector sheet 226 may be obtained by dispersing micro-pores capable of scattering the light in a resin sheet such as PET

The backlight unit 220 also comprises the optical sheets 228 disposed between the light guide plate 224 and the liquid crystal panel 210. The optical sheets 228 allow the light emitted through the light guide plate 224 to effectively enter the viewing plane of the liquid crystal panel 210 so that the brightness is enhanced. The optical sheets 228 also make uniform the light entering the liquid crystal panel 210 so that the brightness uniformity across the viewing plane may be improved.

According to an embodiment of the present invention, the optical sheets 228 are comprised of a diffuser sheet 228a, a prism sheet 228b and a protector sheet 228c.

The diffuser sheet 228a is disposed over the light guide plate 224 in parallel to the light emitting surface 224b. The diffuser sheet 228a has diffusers capable of scattering the light such as beads which are randomly distributed in the diffuser sheet 228a. The diffuser sheet 228a may also have a protective layer with high haze effect and high transmittance. The diffuser sheet 228a scatters the light emitted through the light guide plate 224 so that the brightness becomes uniform across the viewing plane of the liquid crystal panel 210. And, the diffuser sheet 228a widens the viewing angle and hides the patterns formed on the light guide plate 224.

The specified structure and materialistic property of the diffuser sheet 228a are not important to understand and work the present invention, and conventional structure and material normally used in the art are widely applicable to the diffuser sheet 228a of the present invention.

The prism sheet 228b may be disposed over the diffuser sheet 228a to improve the light efficiency and the brightness. The prism sheet 228b may compensate the declination of the brightness which usually happens while the light passes through the diffuser sheet 228a. The prism sheet 228b refracts the light emitted from the diffuser sheet 228a in a low angle to collimate the light toward the front direction so that the brightness is improved within the effective viewing angle.

The specified structure and materialistic property of the prism sheet 228b are not important to understand and work the present invention, and conventional structure and material normally used in the art are widely applicable to the prism sheet 228b of the present invention.

The protector sheet 228c may be disposed over the prism sheet 228b to prevent the surface of the prism sheet 228b from being damaged and re-widens the viewing angle narrowed by the prism sheet 228b within a certain range.

The specified structure and materialistic property of the protector sheet 228c are not important to understand and work the present invention, and conventional structure and material normally used in the art are widely applicable to the protector sheet 228c of the present invention.

Hereinafter, other embodiments of the present invention will be described in detail with reference to the drawings. In the following embodiments, the same reference numbers will be used to refer to the same or like parts as those in the aforementioned embodiment. In addition, detailed descriptions of the identical elements are omitted.

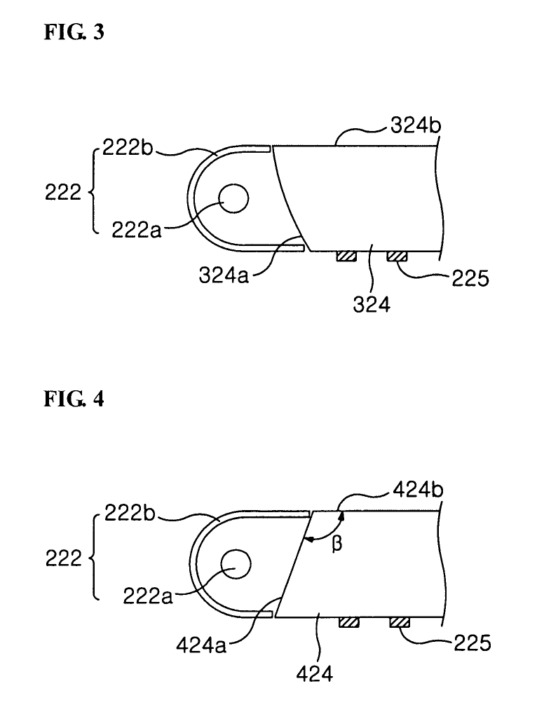

FIGS. 3-5 are partial cross-sectional views illustrating a part of other embodiments of the backlight unit of the present invention, which show the relations between the light source unit 222 and the light guide plate 324, 424 and 524. The other parts not shown in the drawings are the same as those of the aforementioned embodiment.

Referring to FIG. 3, the light guide plate 324 according to another embodiment of the present invention has a curved light incidence surface 324a, and the angle made between any tangent line to the light incidence surface 324a and the light emitting surface 324b is less than 90°. The light incidence surface 324a may also improve the brightness uniformity of the light emitted across the light guide plate 324.

Referring to FIG. 4, the light guide plate 424 according to further another embodiment of the present invention has a light incidence surface which is not perpendicular to the light emitting surface 424b, and also inclined toward the outside of the light guide plate 424. Namely, the angle β made between the light incidence surface 424a and the light emitting surface 424b is larger than 90°. The light incidence surface 424b may also improve the brightness uniformity of the light emitting through the light emitting surface 424b of the light guide plate 424.

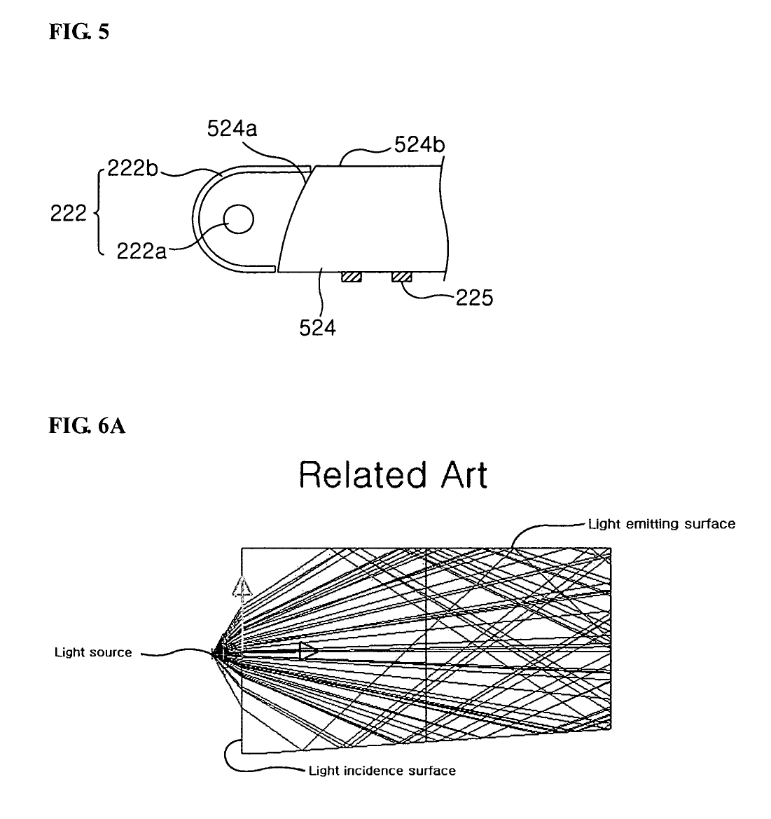

Referring to FIG. 5, the light guide plate 524 according to still further another embodiment of the present invention has a curved light incidence surface 524a, and the angle made between any tangent line to the light incidence surface 524a and the light emitting surface 524b is larger than 90°. The light incidence surface 524a may also improve the brightness uniformity of the light emitted across the light guide plate 524.

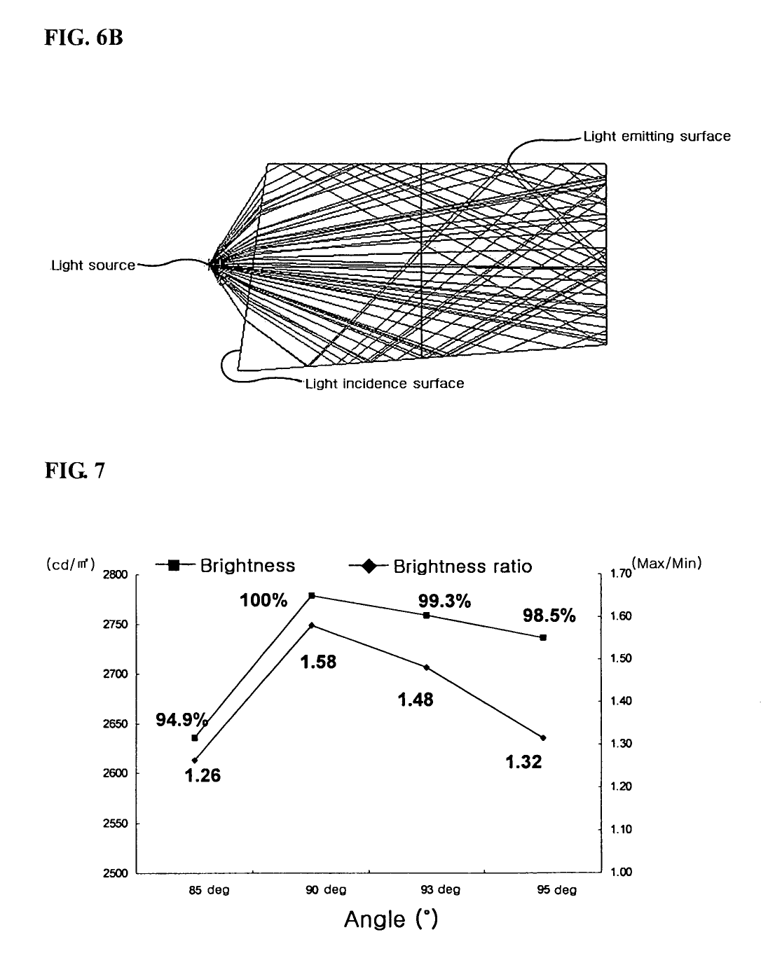

FIGS. 6A-6B illustrate the paths of the light in the light guide plate of the related art and the light guide plate of the present invention respectively. FIG. 6A shows the light paths in the light guide plate where the angle between the light incidence surface and the light emitting surface is 90°, whereas FIG. 6B shows the light paths in the light guide plate where the angle between the light incidence surface and the light emitting surface is 93°

In comparison, when the light is emitted in the same emitting angle from the light source and enters into the two light guide plates respectively, the light is incident on the light emitting surface more uniformly at the light guide plate of the present invention than at the light guide plate of the related art. Therefore, the light guide plate of the present invention may reduce the brightness difference between the central region and the peripheral region of the light guide plate to improve the brightness uniformity across the light guide plate.

FIG. 7 is a diagram illustrating test data measuring the brightness property of the backlight unit of the present invention. The test was conducted regarding the brightness and the brightness uniformity of the following 4 samples at table 1 which were classified according to the angle between the light incidence surface and the light emitting surface.

TABLE 1

| Sample No. | Angle(°) | Material | Size(inches) |
|---|---|---|---|
| 1 | 85 | PMMA | 14.1 |
| 2 | 95 | PMMA | 14.1 |
| 3 | 93 | PMMA | 14.1 |
| 4 | 90 | PMMA | 14.1 |

The prism light guide plate which has an array of prisms on the opposite surface to the light emitting surface was used in this test. Here, the pitch of the prism is 50 μm and the radius of the curvature is 25 μm.

TABLE 2

| Optical sheets | Model | Reference |
|---|---|---|
| Prism sheet | Reverse prism sheet | 50 μm pitch, beads layer |
| Reflector sheet | RP 17N (SKC) | |
| Protector sheet | 125TL2 (Kimoto) | |

In addition, the optical sheets shown at the table 2 were used in the test. RP 17N commercially obtainable from SKC Co., Ltd was used for the reflector sheet, and 125TL2 commercially obtainable from Kimoto Co., Ltd was used for the protector sheet. Further, the reverse prism sheet made of an acrylate resin was used in the test. The reverse prism sheet has micro prisms having a pitch of 50 μm and height of 40 μm and a coating layer formed by applying to its surface a mixture prepared by mixing micro beads with about 8 μm diameter and a urethane-acrylate based binder.

Referring to FIG. 7, the brightness has its peak value in the case where the light incidence surface is perpendicular to the light emitting surface (sample 4), whereas the brightness ratio, which represents the ratio of the brightness value of the brightest part to that of the darkest part, has also its peak value in the case of sample 4. Namely it can be noted that where the light emitting surface is perpendicular to the light incidence surface, the brightness increases but the brightness uniformity decreases.

However, the brightness gradually decreases by less than 6% as the angle between the light emitting surface and the light incidence surface becomes acute or obtuse, but the brightness uniformity sharply increases. For example, in the case where the angle between the light incidence surface and the light emitting surface is 85° (sample 1), the brightness decreases by only about 5%, but the brightness uniformity increases by over 20%.

Therefore, the present invention may provide the backlight unit and the liquid crystal display having considerably improved brightness uniformity while maintaining the brightness at a sufficient level.

What is claimed is:

1. A backlight unit comprising:
a light source generating light; and
a light guide plate configured to transform the light from the light source into surface light, the light guide plate including:
a light incidence surface wherein the light generated from the light source is input into the light guide plate through the light incidence surface; and
a light emitting surface wherein the light input through the light incidence surface is emitted through the light emitting surface in the form of surface light, and wherein the angle which the light incidence surface and the light emitting surface of the light guide plate make with each other is less than 90°.

2. The backlight unit of claim 1, wherein the light incidence surface of the light guide plate is a curved surface.

3. The backlight unit of claim 1, further comprising a prism sheet including an array of micro-prisms disposed in parallel on a surface of the prism sheet, wherein the prism sheet is disposed in the backlight unit in such a manner that the array of micro-prisms faces the light emitting surface of the light guide plate.

4. A backlight unit comprising:
a light source generating light; and
a light guide plate configured to transform the light from the light source into surface light, the light guide plate including:
a light incidence surface wherein the light generated from the light source is input into the light guide plate through the light incidence surface; and
a light emitting surface wherein the light input through the light incidence surface is emitted through the light emitting surface in the form of surface light, and wherein the angle which the light incidence surface and the light emitting surface of the light guide plate make with each other is larger than 90°.

5. The backlight unit of claim 4, wherein the light incidence surface of the light guide plate is a curved surface.

6. The backlight unit of claim 4, further comprising a prism sheet including an array of micro-prisms disposed in parallel on a surface of the prism sheet, wherein the prism sheet is disposed in the backlight unit in such a manner that the array of micro-prisms faces the light emitting surface of the light guide plate.

7. A light guide plate configured to transform the light from a light source disposed adjacent to the light guide plate into surface light, the light guide plate including:
a light incidence surface wherein the light from the light source is input into the light guide plate through the light incidence surface; and
a light emitting surface wherein the light input through the light incidence surface is emitted through the light emitting surface in the form of surface light, and wherein the light incidence surface is not perpendicular to the light emitting surface.

8. The light guide plate of claim 7, wherein the angle which the light incidence surface and the light emitting surface make with each other is less than 90°.

9. The light guide plate of claim 7, wherein the light incidence surface is a curved surface.

10. The light guide plate of claim 7, wherein the angle which the light incidence surface and the light emitting surface make with each other is larger than 90°.

11. The light guide plate of claim 7, wherein the light incidence surface is a curved surface.
